(19) United States
(12) Patent Application Publication
(10) Pub. No.: US 2015/0244779 A1
(43) Pub. Date: Aug. 27, 2015

(54) DISTRIBUTED PERSONAL ANALYTICS, BROKER AND PROCESSING SYSTEMS AND METHODS

(71) Applicant: WYZR LIMITED, Dublin (IE)

(72) Inventor: Cathal Fitzgerald, Dublin (IE)

(21) Appl. No.: 14/497,929

(22) Filed: Sep. 26, 2014

Related U.S. Application Data
(60) Provisional application No. 61/943,140, filed on Feb. 21, 2014.
(60) Provisional application No. 62/015,716, filed on Jun. 23, 2014.

(51) Int. Cl. H04L 29/08; G06Q 30/06; G06F 19/00; H04L 12/927; G06Q 30/02

(52) U.S. Cl. CPC H04L 67/10; H04L 67/16; H04L 47/80; G06Q 30/0277; G06F 19/322; G06Q 30/0641

(57) ABSTRACT

Provided are computer systems, methods, and non-transitory computer-readable medium configured to determine whether the message is allowed to be presented to a user by checking the message with a user profile stored in the storage medium with associated rules. Analytics can be performed on the message and its associated logic and/or data content to identify portions of the message to be presented to the user.

### CROSS REFERENCE TO RELATED APPLICATIONS

This application claims the benefit under 35 U.S.C. §119(e) of U.S. Provisional Application Ser. No. 61/943,140 filed on Feb. 21, 2014 and U.S. Provisional Application Ser. No. 62/015,716 filed on Jun. 23, 2014, the contents of both of which are incorporated by reference in their entirety into the present disclosure.

### BACKGROUND

As of early 2014, the prevalent business model of many of the world's largest internet companies is to give away services for free and profit from private data collected via the free services. Starting in earnest with Hotmail's launch in 1996, a business has grown-up around offering services for free, which up to that point had been subscription based, in exchange for an implicit or opaquely explicit right to resell data about the user scraped from their personal content and communication.

With the advent of Social Networking, this has blossomed to become a multi-billion dollar advertising machine with some of the highest profile companies earning over 95% of their core business earnings from advertising based on the personal data freely collected.

The prevalent technical approach is for these companies to create ‘walled gardens’ where users' data are collected via browsers and, increasingly, mobile apps to be stored centrally, walled off from the rest of the Internet. There is little persistence of data with the owner. Instead the owner is left with a pointer to the central silo where the persistent and authoritative data is stored. Furthermore, a user's personal data becomes heavily fragmented amongst these silos leaving no one with a holistic view of the user's personal data set, not even the user.

These central silos are housed in data centers where the user data is analyzed in order to deliver directed, personalized advertising to users. This is either directly via the provider's app/service or indirectly as the users' profiles are re-sold to data mining and advertising companies. As these companies make their revenue from this centralized pool of personal data there is a virtual arms race on to see who can collect the most valuable personal data on which to sell advertising and data mining rights.

At the same time criminals and hostile government agencies are taking advantage of the high concentration risk that comes from the centralized silo model. Hacking a single site can give access to millions of account holders' details, ranging from credit card details to health data. Denial of service attacks, specifically Distributed Denial of Service Attacks, allow criminals and cyber-terrorists to cost-effectively disrupt the whole business of digital companies.

There are many other examples outside the Social Networking, Search Engine and Ad Tracking businesses where the central collection and analysis of data has become the norm. Loyalty card schemes and Customer Relationship Management (CRM) systems collect detailed personal data about a business' customers in order to better sell more goods or services to them. Here again the thinking is that in order to carry out a meaningful analysis of the customer the first step is to have all their data in a central database where it can be analyzed.

The approach of centralized analysis gives rise to two problems. First, there is the risk associated with storing so much sensitive data in one location, reliant on one set of security measures. The real world analogy to this is the fortified towns used throughout history to defend the inhabitants against attack. These walled towns proved very effective until gunpowder was introduced, which rendered the fortified towns obsolete.

The digital equivalent of gunpowder has now become widely available in the form of botnets, scripted attacks, malware, social engineering, the Internet and inexpensive computing. This has made the once secure bastions of the large data-center ever more vulnerable and their contents ever more expensive to protect. The cost of mounting an attack on such sites has plummeted over the last decade and is now easily and cheaply available.

Secondly, the monetization of personal data has attracted a lot of controversy. Specifically, it is coming under increasing scrutiny from lawmakers, regulators and activists where the prevailing direction is for further tightening of restrictions on exploitation of personal data and increasing privacy rights individuals. As the nature of the personal data being monetized today is much less sensitive than that which will be coming online with the advances in monitoring of all aspect of our lives and health, individual awareness and demands for privacy are likely to become a predominant issue for digital companies in the coming 10 years.

The attempts that have been made to provide a solution in the area of personal data have all been rooted in the centralized approach, both from the storage perspective and from the security perspective. The identification schemes are invariably based on a Public Key Infrastructure (PKI) with a Certification Authority (CA) assigning public/private key pairs to users. Failures of these CAs leave massive vulnerabilities as evidenced by the DigiNotar hacking in 2011.

The technological background against which this is set has also substantially changed in the last decade. In 2004, the year in which Facebook was launched, PCs were the predominant method of access to online content. This was not a device that could be carried around easily, even in portable format, so the centralized model of storage made sense, allowing users to access their content from any computer.

However, in retrospect, calling them personal computers was a misnomer as we can now see with the advent of the smartphone that, to be really personal, we must have it with us at all times. It is in fact the smartphone that has become the first truly personal computer and is now as indispensable to many people as their wallet, if not more so. With over 1 billion smartphones sold in 2013, they have become the norm globally.

This shift to a portable computing device with increasingly large storage, powerful processors and high-speed networking capabilities has brought us to the point where the need for centralized solutions, with all the associated risks and costs, is diminishing rapidly.

### SUMMARY

It is herein contemplated that it is no longer necessary to adhere to the paradigm of central collection and analysis in order to achieve a personalized interaction with the user. Instead, a system and method is provided whereby the data is stored discretely (and discreetly) on a personal computing device(s) in a user profile. The broker, which acts as a trusted intermediary, delivers messages comprising a generic communication and associated logic to the personal computer. The software provided on the personal computer carries out the required analysis against the user profile taking into account the associated logic rules and presents a personalized communications to the user or results to be returned to the requestor. All this is achieved without the personal data needing to leave its owner's possession.

The present disclosure provides computer systems, methods, and non-transitory computer-readable medium configured for secure personal data storage and sharing, for brokering transactions on the personal data, for centrally referencing remote personal data, and carrying out analytics in a distributed fashion on multiple data stores as part of a homogeneous ecosystem.

A major difference between one embodiment of the present technology and the conventional technology is that, whereas the conventional systems work on the basis of persistence and authoritative data residing in central systems with only temporary/cached data stored on the user's device, in the embodiment of the present technology, the persistent and authoritative data remains on the user's device and, other than transitory storage, not on the central systems.

Another major difference with conventional technology is the location where the analytics is carried out. Conventionally, the analytics are carried out on a central data set with the results being used for the desired purpose. Thus, from the point of view of the central actors (e.g., merchants, advertisers, health-care professionals) the interaction is personalized before an interaction occurs. In one embodiment of the present technology, the analytics are carried out in a distributed fashion on the personal computing device(s) and in an ad hoc manner (i.e., when the device is ready to carry-out the task). The central actors need only interact in a generic manner with the users; the personalization can occur at the user device level after the communication has been sent. In this manner, the central actors do not need personal data to achieve their aims.

Thus, in one embodiment, the present disclosure provides a computing device comprising a processor, memory, a non-transitory storage medium, and program code which, when executed by the processor, configures the device to receive a message from a remote message server; determine whether the message is allowed to be presented to a user by checking the message with a user profile stored in the storage medium with associated rules; and store or display the message that is determined to be allowed.

In one embodiment, the present disclosure provides a computing device comprising a processor, memory, a non-transitory storage medium, and program code which, when executed by the processor, configures the device to receive a message from a remote message server; perform analytics on the message to identify a portion of the message to be allowed to be presented to a user; and store or display the portion of the message that is determined to be allowed. In some aspects, the message comes with an associated logic that facilities such analytics.

In some aspects, the message comprises description or promotion of a merchandise. In some aspects, the code further configures the device to provide a visual interface allowing a user to purchase the merchandise.

In some aspects, the message comprises a request to retrieve information from the user profile. In some aspects, the code further configures the device to provide a visual interface to confirm with a user to approve the request or to send the requested information.

In some aspects, the requested information comprises personal healthcare or medical data.

In some aspects, the code further configures the device to, upon a user making a purchase on a website or an application software, retrieve purchase information. In some aspects, the code further configures the device to receive purchase information from a manual input or a payment transaction taking place on the device or at an electronic point of sale. In some aspects, the code further configures the device to store the purchase information in the user profile.

In some aspects, the code further configures the device to receive physiometric or healthcare data of the user and store the data in the user profile.

In some aspects, the user profile is encrypted. In some aspects, decryption of the user profile requires authentication of the user.

In some aspects, the code further comprises the device to determine whether the message is authorized to be delivered to the device. In some aspects, the determination comprises checking message with a key stored in the storage medium.

In likewise fashion, computer-implemented methods and non-transitory medium embedding code for carrying out the above functionalities are also within the scope of this disclosure.

### BRIEF DESCRIPTION OF THE DRAWINGS

Provided as embodiments of this disclosure are drawings which illustrate by exemplification only, and not limitation, wherein:

FIG. 1 illustrates one embodiment of generating user profile with purchase data collected from a purchase transaction and use of a user profile to determine whether an untargeted message is allowed to be presented to the user, as well as use of allowed messages for optional further transaction, such as buying a merchandise presented in a promotion message;

FIG. 2 shows the filtering, selection and optional use of messages sent from a third party system;

FIG. 3 presents a scenario in which a third party requests to analyze data in a user profile and retrieve analysis results upon completion of the analysis, without direct access to the user profile; and

FIG. 4 illustrates that a third party application software in the personal/portalable device, upon access or analysis of data in a user profile, can send a message out to a third party, such as alerting a healthcare provider of a healthcare condition.

It will be recognized that some or all of the figures are schematic representations for exemplification and, hence, that they do not necessarily depict the actual relative sizes or locations of the elements shown. The figures are presented for the purpose of illustrating one or more embodiments with the explicit understanding that they will not be used to limit the scope or the meaning of the claims that follow below.

### DETAILED DESCRIPTION

This disclosure describes a technology that enables secure storage, analysis and potential sharing of personal data. In particular, it is envisioned that data stored locally in a personal/portable device, in particular in an encrypted manner, is more effective in protecting privacy. Along the same line, when analytics that takes personal data as input occurs locally, privacy protection is ensured.

Thus, in one embodiment, the present disclosure provides a computing device with embedded software code for implementing local personal data storage, analysis and/or sharing. The device, in some aspects, includes a processor, memory, a non-transitory storage medium, and program code which, when executed by the processor, configures the device to receive a message from a remote message server; determine whether the message is allowed to be presented to a user by checking the message with a user profile stored in the storage medium with associated rules; and store, display and/or run an analysis based on the message if the message is determined to be allowed.

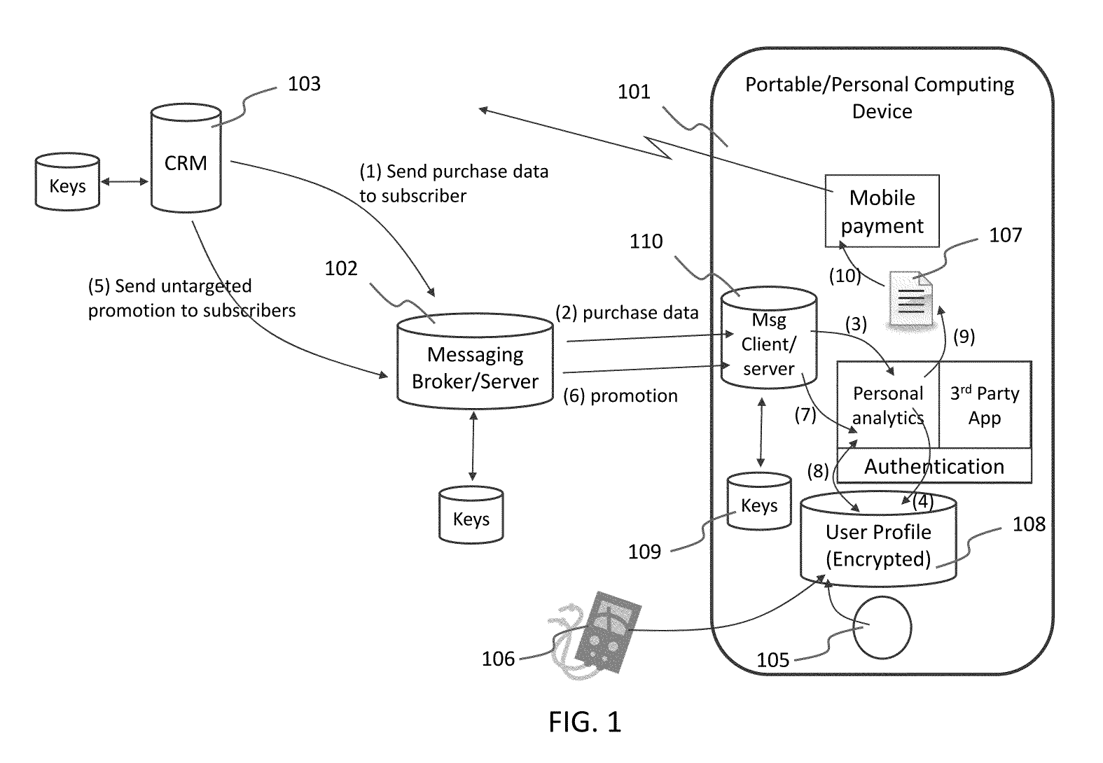

It is understood that the computing device can be any device that includes at least a processor, memory and storage space. In a particular embodiment, the device is a portable (handheld) or personal device such as a smartphone, a wearable device or a tablet (illustrated as 101 in FIG. 1).

### Message and User Profile

The term “message” as used here, refers to any electronic data transmitted between electronic devices. The transmission can be mediated by the Internet, an intranet, or device-to-device wired or wireless communication, such as Wi-Fi, Bluetooth, or NFC (near field communication), without limitation.

In one aspect, a message includes a commercial promotion (e.g., a promotion at step (6) in FIG. 1), such as an advertisement, which includes description or a merchandise. A merchandise can be a good or service, which can be conventional or digital, without limitation.

In one aspect, the message comes with associated logic, which can be used for analytics. The associated logic may define, for example, the applicability criteria of the promotion to be assessed against the user profile.

In one aspect, a message includes a solicitation for a user to participate in an activity, such as taking a survey, joining a program, or sharing data. For instance, the message can be from a medical professional or facility to retrieve personal healthcare history or physiometric data. In another example, the message includes an invitation to participate in a clinical trial subject to the matching of medical data in the user profile with the criteria of the trial.

“Physiometric data” generally refers to data collected from measurement of any physiological characteristic, function or activity of a person. Non-limiting examples of such physiological characteristics include heart rate, blood oxygen or glucose levels, respiration, temperature, etc.

It is noted that, in some aspects, even though the message may be specific to a particular user associated with the device, the message is “untargeted” which means that the sender does not take personal information of the user as input in determining the message content. This is partly because, in these aspects, the sender does not have access to such personal information. Targeted messages (i.e. messages where some known personal information about the recipient in used in formulating the message) can also be delivered but can be subject to similar screening.

When such an untargeted message is received at the device (at, e.g., a message client, 110 in FIG. 1), after certain optional preprocessing, which is described in further details below, the message is checked against a user profile stored in a local storage medium of the device, to determine whether the message is allowed to be presented to the user associated with the user profile.

The term “user profile” as used herein (illustrated as 108 in FIG. 1), refers to any data that can be considered personal to a user, which can be raw, unprocessed records or intelligence derived from such records. In one aspect, a user profile includes the purchasing history, credit card number, travel history, physiometric information, healthcare and medical records, location history, reading or browsing history, content or summary of communication, without limitation. In another aspect, a user profile includes user preferences, such as list of allowed merchandises, types of merchandises, vendors, types of promotion, Internet domains, price or size ranges, color choices, which can be presented to the user. The user profile can be stored as, for instance, a database, data file, or a dataset, without limitation.

### Distributed Local Analytics

The message received at the device can be screened, filtered, modified, organized, and analyzed on the device taking information from the user profile as an input (see step (7) and (8) in FIG. 1). In one aspect, the message is checked against a user preference in the user profile which, for instance, includes a list of allowed vendors. If the message is not sent from one of the vendors in the list, then the message is not presented to the user. Otherwise, it is displayed to the user through, a notification, a visual message, or an alert, or stored in the device for future viewing. Such an allowed message (e.g., through step (9) in FIG. 1) can be referred to as a “personalized message” illustrated as 107 in FIG. 1.

The message, such as those that have been deemed to be allowed, can be analyzed against the relevant accumulated personal data. Non-relevant portions up to and potentially including the entire message can be discarded based on the user profile. Aspects of the user profile that can be analyzed include, but are not limited to, previous purchase history, location, interests, health records, fitness data, etc.

In some aspects, the message comes with associated logic which, optionally along with the content of the message, can be analyzed for the purpose of identifying portions of the message that are allowed to be presented to the user. As provided, the associated logic can define the applicability criteria of the message to be assessed against the user profile. For instance, the associated logic is that a promotion is relevant to and desired by the user because the user has made a purchase of a similar item from a particular vendor. If the user's profile allows such a promotion, then such a logic qualifies the message for allowance. In another example, if the associated logic is that the new medical product is useful for patients of certain conditions and the user's profile contains data indicative of such a condition and the profile further defines the user accepts to receive solicitations for such products, then the message is allowed.

In one aspect, the associated logic is inclusion or exclusion of a particular type or class of messages. For instance, a message can only be valid and presented to a user if the user's profile indicates that the user has purchased similar items before (inclusion) or if the user's profile indicates that the user has not purchased similar items before (exclusion).

In one aspect, the associated logic is distance (locality). For instance, a message is only valid within a certain region or geo-fenced area, and can only be presented to a user in that region or geo-fenced area, as indicated in the user profile or by the device.

Likewise, in one aspect, the associated logic relates to time (i.e., temporal criteria). Under this logic, for instance, a message is only valid during a designated time period. In some aspects, the associated logic includes a combination or sub-combination of any of the above.

For the purpose of non-promotional analytics, the user can accept requests to carry out data-mining on their personal data by a third party in return for remuneration or other incentive. This may include analyzing correlations or variances between any or all of the personal data stored.

Examples of such analysis include, without limitation, correlation between health (including genetic information), fitness, consumption and lifestyle data in determining causality for actuarial or medical research. The results of the analysis can be returned to the entity carrying out the research without the personal data leaving the user's personal computing device.

Cryptographic signatures and hashes of the relevant data can ensure the veracity of the responses to the receiving party. In this way contracts can be concluded based on personal data without the contracting party needing access to the personal data.

An example of such a transaction is an insurance contract. The party offering the insurance sends a request for analysis on the personal data to the user. The results of the analysis can, for instance, be a risk rating based on the personal data. The result returned to the insurer is the risk rating plus the hash of the analyzed data in a message signed by the user. This provides a means of non-repudiation to the insurer without having to hold the personal data.

Predictive analysis can also be carried out based on the stored personal data. Such analysis can entail rules for the predictive analysis to be sent to and accepted by the user. The predictive analysis can combine personal data, including communication content, as well as location, time and other contextual data. The results of this predictive analysis can, at the users discretion, be made available to the user or may be made available to a third party(s).

To implement the local analytics, the device allows installation and running of third party application software. Nevertheless, in one aspect, the third party application software is not allowed to transmit information in the user profile to a remote device, without authorization from the user, as further described below in data sharing. In one aspect, the third party application software only has access to data that the user authorizes it to access. In one aspect, analytics is carried out on an individual basis on the user's device.

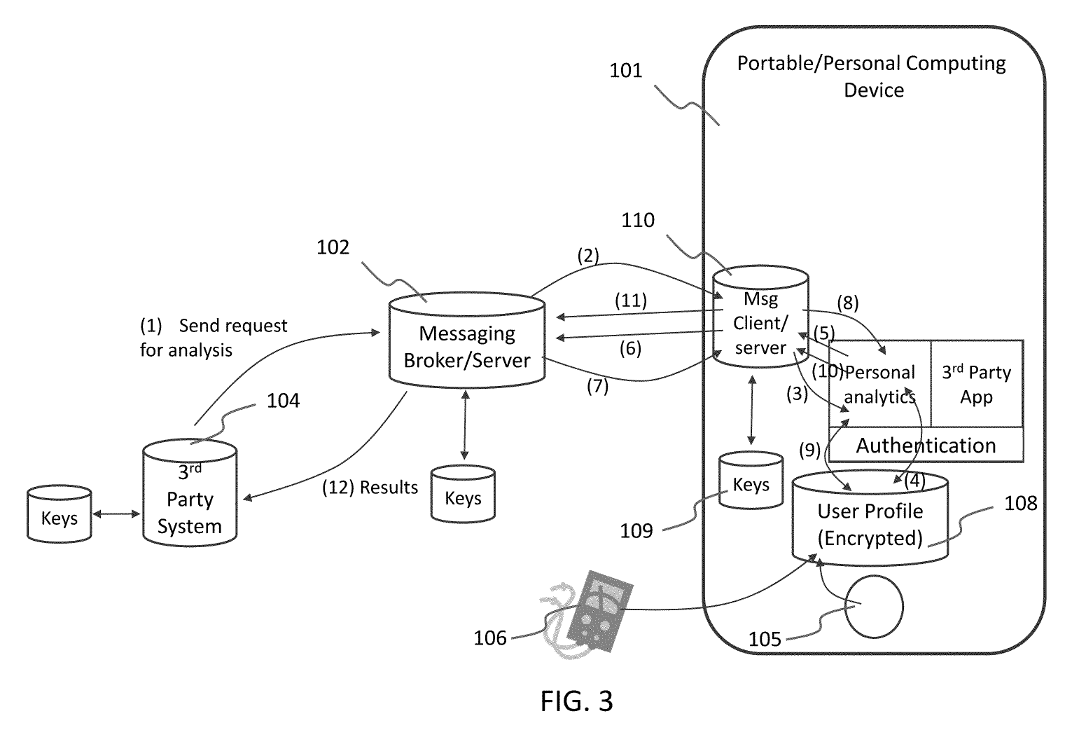

FIG. 3 illustrates a case in which personal data is analyzed locally on a personal/portable device with results shared with a third party, optionally including a portion of the personal data. A third party system (104) sends a request for data analysis to the messaging broker 102 (step 1) which sends a request to the message client 110 (step 2) for permission to forward the analysis request. The message client checks the request against the user profile (steps 3 and 4) and sends back to the messaging broker (step 6) either an authorization or a denial. If allowed, the messaging server forwards the analysis request to the message client (step 7).

Local analysis with data in the user profile is then conducted (step 9) and the result is sent back to the message client (step 10) which in turn forwards the results to the messaging broker (step 11) and then to the third party system (step 12). Optionally, upon request and authorization by the user, certain portion of the personal data can be also sent back with the result.

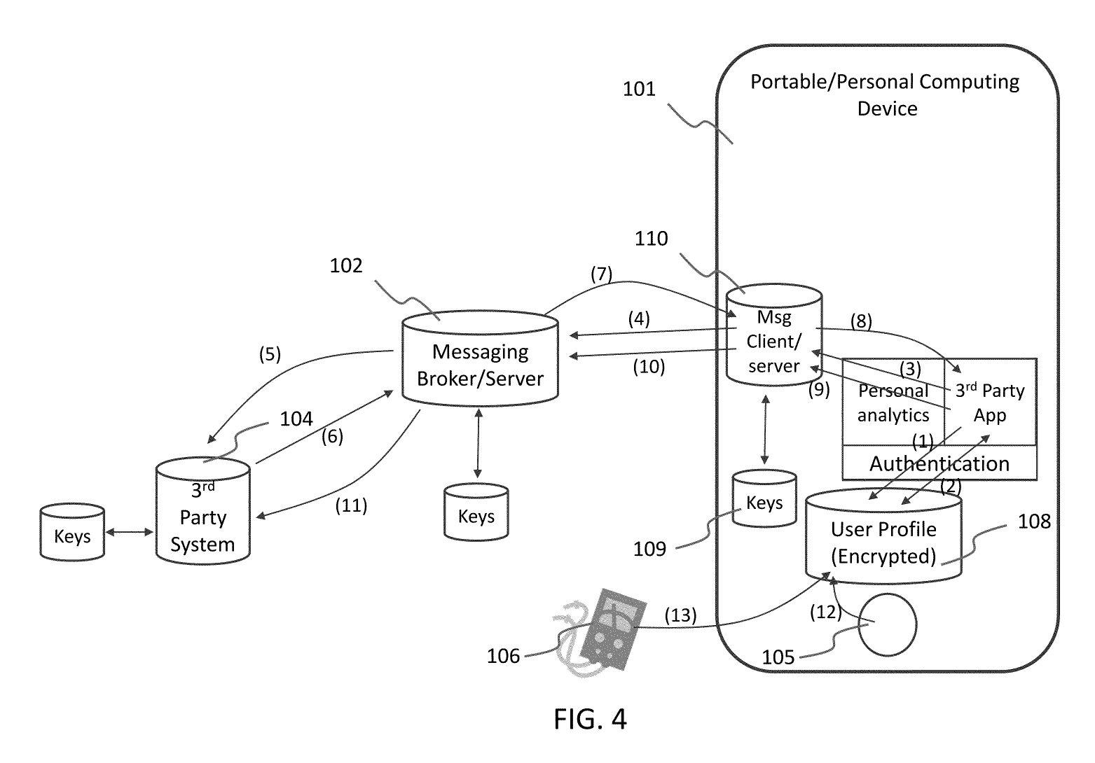

In some aspects, local data analysis can commence without a remote request. For instance, in FIG. 4, a third party application program requests (step 1), e.g., automated at certain predetermined time or initiated by a user, to access data in the user profile, such as healthcare/physiometric data in the user profile. The data is made available to the third party application software (step 2) and is analyzed. In the event the application software identifies an issue that meets predefined criteria (e.g., a medical emergency), the third party application software sends a message (step 3) to the message client. In one aspect, step 3 is automated. In another aspect, step 3 requires further confirmation, e.g., on a visual interface, from the user.

Once the message client receives that message, it relays the message to a third party system (104) through the messaging broker (102) (steps 4 and 5) which can respond to such a message (steps 6-7). The response is received at the device 101, subject to further filtering, selection or analysis (step 8). If needed, the analysis result is transmitted back to the third party system (steps 9-11). In some aspect, the message includes purchase request and the third party system is a vendor.

In some aspects, the message includes health data and the third party system is a healthcare provider. In these aspects, the personal device or the third party system can request to collect further physiometric information from the user, and such data can be collected from an on-board physiometric sensor (105) or an external physiometric sensor (106) (steps 12 or 13).

### Sharing of Personal Data

In another aspect, the message is a solicitation to share personal data. The analytics can then determine whether the data can be shared to the requester, what data is to be shared, and/or in what format.

In some aspects, no personal data can be shared without explicit authorization by the user. In that respect, the device is configured to provide a visual interface to confirm with the user to approve the request or to send the requested information.

In some aspects, the data requested to be shared includes healthcare, medical data, or financial data.

In some aspects, the data shared is subject to constraints indicated in the message returning the data such as, but not limited to, retention period, or allowable uses.

### Generation of User Profile

In relation to the disclosed local data access and analysis, the present technology also envisions a system that enables retrieval of personal data from any remote device for local storage so that no personal data needs or should be kept remotely.

In one aspect, when a user conducts a purchase with a merchant using an associated Customer Relationship Management (CRM) module (103 in FIG. 1), the CRM module pushes the transaction data to the user's device, (e.g., steps (1)-(4) in FIG. 1) to save in the local user profile. The remote server, on the other hand, keeps no personally identifiable data.

In this context, it is noted that, in the conventional approach to CRM, a customer conducts a commercial transaction and then the transaction is recorded in the seller's CRM system along with details of the customer. This is used to build up a profile of the customer, to track customer interactions and as a sales/marketing tool. The present technology provides, in some embodiments, a light CRM module whereby once a transaction is completed, the transaction data is pushed to the customer's device (as opposed to retrieved). Thereafter the central record need only be an anonymous or pseudonymous copy of the data.

In another aspect, data in the user profile can be generated when a payment is made by the device, even though the entire purchase transaction is not competed through the device. Along with the payment information, information such as where the purchase is made and the type of the purchase can also be included in the user profile.

Yet, in another aspect, the device is configured to enable the user to enter information to be stored in the user profile. The information can be purchase history, physiometric data, or healthcare records. For instance, physiometric information can be entered through an onboard physiometric sensor (105 in FIG. 1) or a wire or wireless connected physiometric sensor (106 in FIG. 1). In another aspect, the information can be generated from a third party application software installed or running on the device.

For instance, data can be entered via an API from a pre-existing source of the user's personal data, such as with a “Blue Button” functionality (a facility for users to download their own health data) of existing health-care services may be used to retrieve data for storage in the user profile.

In a similar fashion, messaging or social-networking platforms that allow users to download their data can be used as a source of data for the user's profile. Likewise, a messaging or communication application can be adapted to store messages in the user's profile. In some aspects, data are transferred to the user profile by the user by means of wired or wireless communications networks.

### Untargeted Message from a Third Party

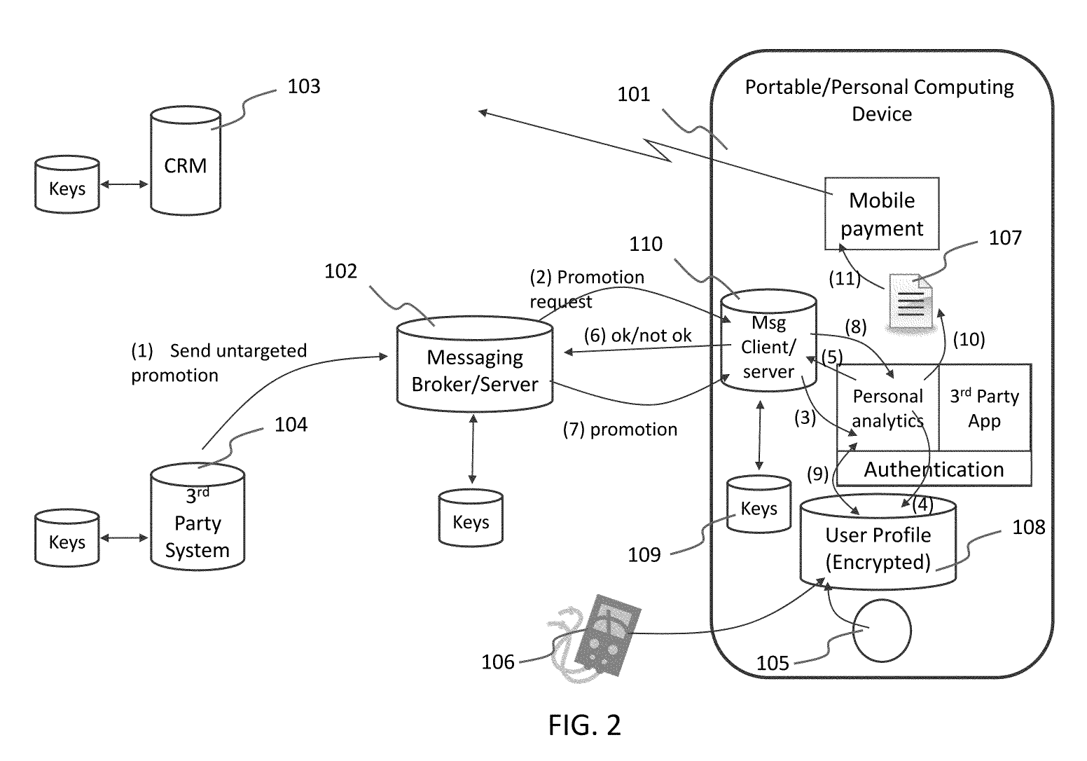

In one aspect, as illustrated in FIG. 1, an untargeted message can be sent from a CRM that generates the original purchase data, where the CRM has already been configured to communicate with the message broker 102. In another aspect, the untargeted message can also be sent from a third party system (104), as illustrated in FIG. 2, via an Application Programming Interface (API) of the message broker.

With reference to FIG. 2, a third party system (104) sends an untargeted message to message broker (102) which screens the message for spam control (step 1). If authorized by the message broker, a request is then sent to the message client on the personal device 101 (step 2). There, the message client can check the request against keys stored in the keychain database (109) and/or the user profile (steps 3 and 4) to determine whether the message is from a vendor that the user allows.

Subsequently, the message client sends an authorization or denial (step 6) to the message broker, which in turns relays the message to the message client if allowed (step 7). The message is then subject to checking or analysis with the user profile (step 9) and potentially to be personalized (step 10), and potentially allow the user to make a transaction or payment (step 11).

### Anonymous Request for Product or Service

With reference to FIG. 2, it is also possible to reverse the sense of offer and demand. For example, a user may send to potential suppliers a solicitation for a certain product or service where the broker intermediates. In this way the user remains anonymous from the point of view of the suppliers of services. The broker retains a pseudonymous reference allowing replies to be delivered to the user.

### Encryption of User Profile

The user profile can be encrypted, when stored in the device, to improve security. In this respect, access to the user profile requires authentication, which can be done, for instance, by prompting the user to enter a password, a pin number, collecting a fingerprint or any other means, without limitation. A combination of symmetric and asymmetric cryptography can be used to encrypt and protect access to the profile.

A copy of the encrypted data, in one aspect, is stored on a separate device for resilience purposes without the means of decrypting or otherwise interacting with the encrypted data.

In another aspect, a copy of the encryption keys is to be kept in a separate device/location in an appropriate manner/format. This can include printing the keys, generating QR or other visual encodings of the keys or storing the keys in electronic format on another secure or air-gapped device.

Further, the user may, for increased security, keep a private key on an external hardware, only sharing it with the device using, for example but not limited to, NFC when a signature is needed.

### Use of Personalized Message

A personalized message (e.g., 107 in FIG. 1) that is determined by the device, taking information in the user profile as input, can be further processed or used. For instance, the device can be configured to display an interface allowing the user to make a purchase, make a payment, checking out more information, take a survey, sharing data, or join a program or clinical trial.

In one aspect, the device is configured to provide a visual interface to allow the user to make a purchase of a merchandise described in the personalized promotion message. In another aspect, the device is configured to use localization information to display a visual interface providing suggestions or promotions to the user based on preferences stored in the user profile.

### Messaging Broker and Message Authentication

To ensure that vendors or any other types of message senders comply with privacy protection the present disclosure prescribes, in one embodiment, a message broker/server is set up. As illustrated in FIG. 1, the message broker (102) receives untargeted promotion or purchase data from a message sender, and redirects the message or purchase data to the intended user's portable/personal device (101). This message may come from a CRM (103) module or a third party system.

The message can optionally be encrypted using a public key of the recipient such that only the end recipient may decrypt the message. The message content is in this way not accessible/readable by the message broker.

The message broker may carry out certain filtering or selection to reduce spam. In another aspect, the message broker can play an integral part of a message authentication system, along with a keychain database (109) in the device.

A message, for instance, can be authenticated by checking it against a stored public key (in, e.g., a key in keychain database 109) of a trusted correspondent. There can be multiple layers of authentication for a given message, in some aspects.

### Computer Systems and Network

The methodology described here can be implemented on a computer system or network. A suitable computer system can include at least a processor and memory; optionally, a computer-readable medium that stores computer code for execution by the processor. Once the code is executed, the computer system carries out the described methodology.

In this regard, a “processor” is an electronic circuit that can execute computer programs. Suitable processors are exemplified by but are not limited to central processing units, microprocessors, graphics processing units, physics processing units, digital signal processors, network processors, front end processors, coprocessors, data processors and audio processors. The term “memory” connotes an electrical device that stores data for retrieval. In one aspect, therefore, a suitable memory is a computer unit that preserves data and assists computation. More generally, suitable methods and devices for providing the requisite network data transmission are known.

Also contemplated is a non-transitory computer readable medium that includes executable code for carrying out the described methodology. In certain embodiments, the medium further contains data or databases needed for such methodology.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above also come within the scope of “machine-readable media.” Machine-executable instructions comprise, for example, instructions and data that cause a general purpose computer, special-purpose computer or special-purpose processing machine(s) to perform a certain function or group of functions.

Embodiments of the present disclosure have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present disclosure may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the disclosure also may be practiced in distributed and cloud computing environments where tasks are performed by local and remote processing devices that are linked, by hardwired links, by wireless links or by a combination of hardwired or wireless links, through a communications network. In a distributed computing environment, program modules may be located in both local and remote memory storage devices.

Although the discussions above may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this disclosure belongs.

The disclosures illustratively described herein may suitably be practiced in the absence of any element or elements, limitation or limitations, not specifically disclosed here. For example, the terms “comprising”, “including,” containing,” etc. shall be read expansively and without limitation. Additionally, the terms and expressions employed here have been used as terms of description and not of limitation; hence, the use of such terms and expressions does not evidence and intention to exclude any equivalents of the features shown and described or of portions thereof. Rather, it is recognized that various modifications are possible within the scope of the disclosure claimed.

By the same token, while the present disclosure has been specifically disclosed by preferred embodiments and optional features, the knowledgeable reader will apprehend modification, improvement and variation of the subject matter embodied here. These modifications, improvements and variations are considered within the scope of the disclosure.

The disclosure has been described broadly and generically here. Each of the narrower species and subgeneric groupings falling within the generic disclosure also form part of the disclosure. This includes the generic description of the disclosure with a proviso or negative limitation removing any subject matter from the genus, regardless of whether or not the excised material is described specifically.

Where features or aspects of the disclosure are described by reference to a Markush group, the disclosure also is described thereby in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

Although the disclosure has been described in conjunction with the above-mentioned embodiments, the foregoing description and examples are intended to illustrate and not limit the scope of the disclosure. Other aspects, advantages and modifications within the scope of the disclosure will be apparent to those skilled in the art to which the disclosure pertains.

1. A computing device comprising a processor, memory, a non-transitory storage medium, and program code which, when executed by the processor, configures the device to:
receive a message from a remote message server;
determine whether the message is allowed to be presented to a user by checking the message with a user profile stored in the storage medium with associated rules; and
store or display the message that is determined to be allowed.

2. The device of claim 1, wherein the code further configures the device to perform analytics on the message, thereby identifying a portion of the message to be allowed to be presented to the user.

3. A computing device comprising a processor, memory, a non-transitory storage medium, and program code which, when executed by the processor, configures the device to:
receive a message from a remote message server;
perform analytics on the message to identify a portion of the message to be allowed to be presented to a user; and
store or display the portion of the message that is determined to be allowed.

4. The device of claim 2, wherein the message is received along with associated logic of relevance to the user.

5. The device of claim 1, wherein the message comprises description or promotion of a merchandise.

6. The device of claim 5, wherein the code further configures the device to provide a visual interface allowing a user to purchase the merchandise or further act on the promotion offer.

7. The device of claim 1, wherein the message comprises a request to retrieve information from the user profile.

8. The device of claim 7, wherein the code further configures the device to provide a visual interface to confirm with a user to approve the request or to send the requested information.

9. The device of claim 8, wherein the requested information comprises personal healthcare or medical data.

10. The device of claim 5, wherein the code further configures the device to, upon a user making a purchase on a website or an application software, retrieve purchase information.

11. The device of claim 5, wherein the code further configures the device to receive purchase information from a manual input or a payment transaction taking place on the device.

12. The device of claim 10, wherein the code further configures the device to store the purchase information in the user profile.

13. The device of claim 1, wherein the code further configures the device to receive physiometric or healthcare data of the user and store the data in the user profile.

14. The device of claim 1, wherein the user profile is encrypted.

15. The device of claim 14, wherein decryption of the user profile requires authentication of the user.

16. The device of claim 1, wherein the code further comprises the device to determine whether the message is authorized to be delivered to the device.

17. The device of claim 16, wherein the determination comprises checking message with a key stored in the storage medium.

18. A non-transitory computer-readable medium comprising code which, when executed by a computing device, configures the device to:
receive a message from a remote message server;
determine whether the message is allowed to be presented to a user by checking the message with a user profile stored in the storage medium with associated rules; and
store or display the message that is determined to be allowed.
